(19) United States
(12) Patent Application Publication
(10) Pub. No.: US 2016/0212466 A1
(43) Pub. Date: Jul. 21, 2016

(54) Automatic system and method for determining individual and/or collective intrinsic user reactions to political events

(71) Applicant: Krush Technologies, LLC, Dayton, OH (US)

(72) Inventors: John P. Nauseef, Kettering, OH (US); Brian T. Faust, Springboro, OH (US); Matthew J. Farrell, Springboro, OH (US); Christopher S. Wire, Dayton, OH (US)

(73) Assignee: Krush Technologies, LLC, Dayton, OH (US)

(21) Appl. No.: 15/003,769

(22) Filed: Jan. 21, 2016

Related U.S. Application Data
(60) Provisional application No. 62/106,127, filed on Jan. 21, 2015.

(51) Int. Cl. H04N 21/258; H04N 21/81; H04N 21/2668; H04N 21/442; H04N 21/234; H04N 21/233

(52) U.S. Cl. CPC H04N 21/25891; H04N 21/23418; H04N 21/233; H04N 21/2668; H04N 21/44218; H04N 21/8133

(57) ABSTRACT

Embodiments disclosed herein may be directed to a video content server for: receiving, using a communication unit, a video stream of a user of a user device; analyzing, using a graphical processing unit (GPU), the video stream in real time; identifying, using a recognition unit, at least one object of interest comprised in the video stream; assigning, using a gesture analysis unit, at least one numerical value associated with at least one predetermined emotion to the at least one object of interest; and generating, using a reporting unit, a score indicating relevance of political content to the user based at least in part on the at least one numerical value.

### CROSS REFERENCE TO RELATED APPLICATION

This application is a nonprovisional application of, and claims priority to, U.S. Provisional Patent Application No. 62/106,127 filed on Jan. 26, 2015, the disclosure of which is hereby incorporated by reference in its entirety.

### TECHNICAL FIELD

Embodiments disclosed herein relate to an automatic system and method for determining individual and/or collective intrinsic user reactions to political events.

### BACKGROUND

In politics, as in marketing and other fields, it is useful to be able to objectively measure how successfully a message resonates with its intended recipient. Prior methods of assessing user behavior of the intended recipient rely on subjective measures, be it depending on the subjectivity of an external observer who might be watching a person who is being “measured” (e.g., the recipient), or the self-subjectivity of the intended recipient, who might turn a dial or provide another self-subjective assessment of her or his impressions of a video message or other media she or he is watching, hearing, and/or otherwise receiving.

### SUMMARY

Briefly, aspects of the present invention relate to utilizing facial gesture recognition and audio-visual analysis techniques described herein to determine emotionally-intelligent political data of target audiences. In some embodiments, a video content server is provided. The video content server comprises: at least one memory comprising instructions; and at least one processing device configured for executing the instructions, wherein the instructions cause the at least one processing device to perform the operations of: receiving, using a communication unit comprised in the at least one processing device, a video stream of a user of a user device; analyzing, using a graphical processing unit (GPU) comprised in the at least one processing device, the video stream in real time; identifying, using a recognition unit comprised in the at least one processing device, at least one object of interest comprised in the video stream; assigning, using a gesture analysis unit comprised in the at least one processing device, at least one numerical value associated with at least one predetermined emotion to the at least one object of interest; and generating, using a reporting unit comprised in the at least one processing device, a score indicating relevance of political content to the user based at least in part on the at least one numerical value.

In some embodiments, the at least one object of interest comprises at least one of a facial feature, a facial gesture, a vocal inflection, a vocal pitch shift, a change in word delivery speed, a keyword, an ambient noise, and an environment noise.

In some embodiments, the video stream comprises a live video feed of the face of a user during playback of the political content, and wherein identifying the at least one object of interest comprises: identifying, using the recognition unit, a facial feature of the user in the live video feed at a first time; identifying, using the recognition unit, the facial feature of the user in the live video feed at a second time; and determining, using the recognition unit, movement of the facial feature from a first location at the first time to a second location at the second time, wherein the determined movement is assigned the at least one numerical value.

In some embodiments, the video stream comprises a live audio feed of the face of a user during playback of the political content, and wherein identifying the at least one object of interest comprises: identifying, using the recognition unit, a first vocal pitch of the first user in the live audio feed at a first time; identifying, using the recognition unit, a second vocal pitch of the first user in the live audio feed at a second time; and determining, using the recognition unit, a change of vocal pitch of the first user, wherein the determined change of vocal pitch is assigned the at least one numerical value.

In some embodiments, the instructions cause the at least one processing device to perform the operations of: generating, using the reporting unit, a report comprising the score and at least one of demographic information, personal information, political information, a graph, an email, a text message, and an infographic; and transmitting, using the communication unit, the report to a user device associated with the user.

In some embodiments, the instructions further cause the at least one processing device to perform the operations of: transmitting, using the communication unit, the political content to a user device associated with the user, wherein the video stream is received in response to playback of the political content on the user device.

In some embodiments, identifying the at least one object of interest comprises: determining, using the GPU, a numerical value of at least one pixel associated with the at least one object of interest.

In some embodiments, a non-transitory computer readable medium comprising code, wherein the code, when executed by at least one processing device of a video content server, causes the at least one processing device to perform the operations of: receiving, using a communication unit comprised in the at least one processing device, a video stream of a user of a user device; analyzing, using a graphical processing unit (GPU) comprised in the at least one processing device, the video stream in real time; identifying, using a recognition unit comprised in the at least one processing device, at least one object of interest comprised in the video stream; assigning, using a gesture analysis unit comprised in the at least one processing device, at least one numerical value associated with at least one predetermined emotion to the at least one object of interest; and generating, using a reporting unit comprised in the at least one processing device, a score indicating relevance of political content to the user based at least in part on the at least one numerical value.

In some embodiments, the at least one object of interest comprises at least one of a facial feature, a facial gesture, a vocal inflection, a vocal pitch shift, a change in word delivery speed, a keyword, an ambient noise, and an environment noise.

In some embodiments, the video stream comprises a live video feed of the face of a user during playback of the political content, and wherein the non-transitory computer readable medium further comprises code that, when executed by the at least one processing device of the video content server, causes the at least one processing device to perform the operations of: identifying, using the recognition unit, a facial feature of the user in the live video feed at a first time; identifying, using the recognition unit, the facial feature of the user in the live video feed at a second time; and determining, using the recognition unit, movement of the facial feature from a first location at the first time to a second location at the second time, wherein the determined movement is assigned the at least one numerical value.

In some embodiments, the video stream comprises a live audio feed of the face of a user during playback of the political content, and wherein the non-transitory computer readable medium further comprises code that, when executed by the at least one processing device of the video content server, causes the at least one processing device to perform the operations of: identifying, using the recognition unit, a first vocal pitch of the first user in the live audio feed at a first time; identifying, using the recognition unit, a second vocal pitch of the first user in the live audio feed at a second time; and determining, using the recognition unit, a change of vocal pitch of the first user, wherein the determined change of vocal pitch is assigned the at least one numerical value.

In some embodiments, the non-transitory computer readable medium further comprises code that, when executed by the at least one processing device of the video content server, causes the at least one processing device to perform the operations of: generating, using the reporting unit, a report comprising the score and at least one of demographic information, personal information, political information, a graph, an email, a text message, and an infographic; and transmitting, using the communication unit, the report to a user device associated with the user.

In some embodiments, the non-transitory computer readable medium further comprises code that, when executed by the at least one processing device of the video content server, causes the at least one processing device to perform the operations of: transmitting, using the communication unit, the political content to a user device associated with the user, wherein the video stream is received in response to playback of the political content on the user device.

In some embodiments, the non-transitory computer readable medium further comprises code that, when executed by the at least one processing device of the video content server, causes the at least one processing device to perform the operations of: determining, using the GPU, a numerical value of at least one pixel associated with a facial feature identified in the video content.

In some embodiments, a method is provided. The method comprises: receiving, using a communication unit comprised in at least one processing device of a video content server, a video stream of a user of a user device; analyzing, using a graphical processing unit (GPU) comprised in the at least one processing device, the video stream in real time; identifying, using a recognition unit comprised in the at least one processing device, at least one object of interest comprised in the video stream; assigning, using a gesture analysis unit comprised in the at least one processing device, at least one numerical value associated with at least one predetermined emotion to the at least one object of interest; and generating, using a reporting unit comprised in the at least one processing device, a score indicating relevance of political content to the user based at least in part on the at least one numerical value.

In some embodiments, the at least one object of interest comprises at least one of a facial feature, a facial gesture, a vocal inflection, a vocal pitch shift, a change in word delivery speed, a keyword, an ambient noise, and an environment noise.

In some embodiments, the video stream comprises a live video feed of the face of a user during playback of the political content, and wherein the method further comprises: identifying, using the recognition unit, a facial feature of the user in the live video feed at a first time; identifying, using the recognition unit, the facial feature of the user in the live video feed at a second time; and determining, using the recognition unit, movement of the facial feature from a first location at the first time to a second location at the second time, wherein the determined movement is assigned the at least one numerical value.

In some embodiments, the video stream comprises a live audio feed of the face of a user during playback of the political content, and wherein the method further comprises: identifying, using the recognition unit, a first vocal pitch of the first user in the live audio feed at a first time; identifying, using the recognition unit, a second vocal pitch of the first user in the live audio feed at a second time; and determining, using the recognition unit, a change of vocal pitch of the first user, wherein the determined change of vocal pitch is assigned the at least one numerical value.

In some embodiments, the method further comprises: generating, using the reporting unit, a report comprising the score and at least one of demographic information, personal information, political information, a graph, an email, a text message, and an infographic; and transmitting, using the communication unit, the report to a user device associated with the user.

In some embodiments, the method further comprises: transmitting, using the communication unit, the political content to a user device associated with the user, wherein the video stream is received in response to playback of the political content on the user device.

### BRIEF DESCRIPTION OF THE DRAWINGS

Reference is now made to the following detailed description, taken in conjunction with the accompanying drawings. It is emphasized that various features may not be drawn to scale and the dimensions of various features may be arbitrarily increased or reduced for clarity of discussion. Further, some components may be omitted in certain figures for clarity of discussion.

FIG. 1 shows an exemplary politics-focus video player application, in accordance with some embodiments of the disclosure;

FIG. 2 shows an exemplary system environment, in accordance with some embodiments of the disclosure;

FIG. 3 shows an exemplary computing environment, in accordance with some embodiments of the disclosure;

FIG. 4 shows an exemplary report of political data, in accordance with some embodiments of the disclosure;

FIG. 5 shows an exemplary report of political data, in accordance with some embodiments of the disclosure;

FIG. 6 shows an exemplary report of political data, in accordance with some embodiments of the disclosure;

FIG. 7 shows an exemplary method of performing operations associated with generating a score indicating relevance of political content to a user based on visually-detected emotional responses of the user, in accordance with some embodiments of the disclosure; and

FIG. 8 shows an exemplary method of performing operations associated with generating a score indicating relevance of political content to a user based on auditory emotional responses of the user, in accordance with some embodiments of the disclosure.

### DETAILED DESCRIPTION

### Introduction

Embodiments of the present disclosure may be directed to a system that enables analysis and reporting of political data based on information associated with emotional responses to political content. For example, the system may provide political content (e.g., images, video and/or audio content, web page presentations, and/or the like) to a user via a user device. While viewing the video content, the system may, using a camera and/or a microphone included in the user device, capture video of the user's face and/or audio of the user's voice during video playback. The system may then analyze captured video and/or audio of the user to identify one or more emotional responses communicated by the user's facial expressions, facial gestures, vocal inflections, speech patterns, spoken keywords, and/or the like. Identifying emotional responses of users may enable the system to determine the manner in which the political content was received by an audience. The system may then generate one or more reports of political data associated with user reception of the political content. In this way, emotional intelligence associated with emotional responses to political content may be utilized to determine how effective political content may be to an audience in a quicker and more efficient manner than traditional methods.

### Illustrative Example

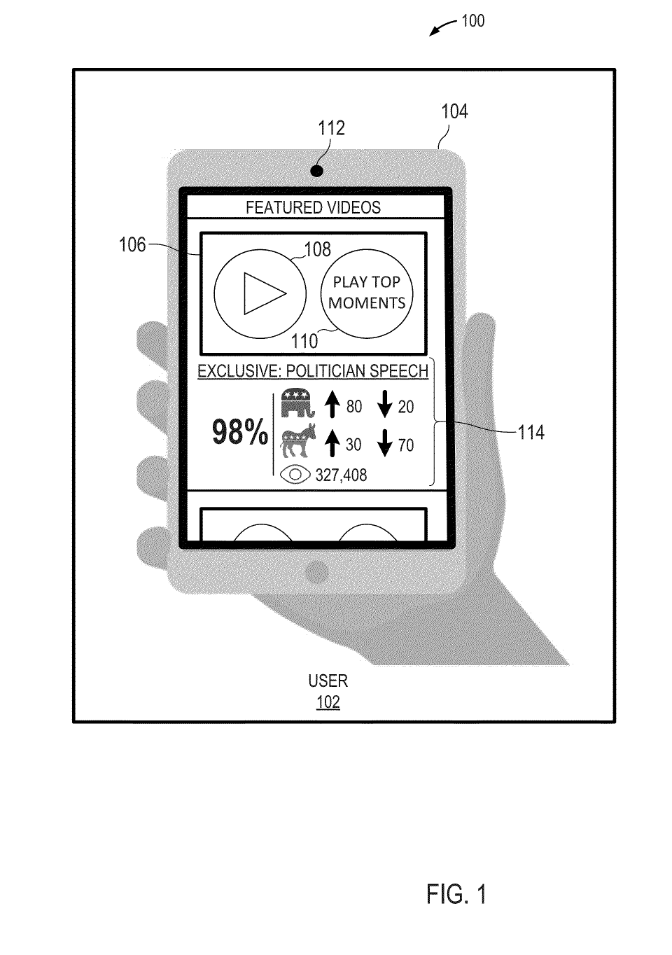

Referring now to the Figures, FIG. 1 illustrates an exemplary user experience 100 for enabling a user 102 of a user device 104 to view political content 106. Political content 106 may include videos, images, and/or audio of various political discussions, speeches, debates, propaganda, campaigns, polls, information, and/or the like. In some embodiments, the user 102 may be enabled, via the user device 104, to view political content in its entirety 110 (e.g., watch an entire live debate, listen to an entire speech, and/or the like) and/or view top moments 112 (e.g., highlights, post-event analysis, and/or the like) of a political event. In some embodiments, the political content may be accessed by the user 102 using a software application running on the user device 104.

During playback of the political content (e.g., while the user 102 views the political content), the user 102 may hold the user device 104 in front of her or his face so that a camera 110 (e.g., a sensor) included in the user device 104 may capture a live video feed of the user's face. Additionally, audio of the user 102 may be captured by a microphone (not pictured) included in the user device 104 while the user 102 views the political content.

A video content server (and/or a decision engine associated with the video content server) facilitating distribution of the political content to the user device 104 may receive the live video and/or audio feeds of the user 102 captured during playback of the political content. The video content server may analyze the live video and/or audio feeds to detect emotional cues (e.g., facial features, facial feature movements, facial gestures, vocal inflections, and/or speech patterns) of the user 102 expressed in response to viewing the political content. Emotional cues identified during analysis of the live video and/or audio feeds of the user 102 may correspond to one or more emotions felt by the user 102 during playback of the political content. In some embodiments, emotional cues may be identified by the video content server using a variety of video and/or audio analysis techniques including comparisons of pixels, comparisons of facial feature locations over time, detection of changes in vocal pitch, spoken keyword identification, and/or the like.

An exemplary emotional cue identification may include the video content server detecting raised eyebrows and a smile of the first user 102 (e.g., facial feature movement) in response to viewing political content at a particular time. Based on an analysis of the detected emotional cues (e.g., the raising of eyebrows and the mouth's formation of a smile), the video content server may determine, using on a predetermined table and/or database of known emotional cues corresponding to emotions, that the user 102 is displaying emotional cues associated with joy and/or happiness. The video content server may then determine that the user 102 has responded positively to the political content at that particular time.

Accordingly, the video content server may generate a report 114 including a summary of how the user 102 and/or an audience responded to the political content. The report 114 may include a relevance score associated with how relevant the political content is to the user 102 based on an analysis of other users' emotional responses to the political content and a user profile and/or user preferences of the user 102. The report 114 may include a summary of responses to political content based on various pieces of demographic information, political affiliations, and/or the like. In this manner, the video content server may determine how political content is received by an audience based on identified emotional responses of users (e.g., the user 102) of the audience. Political content may then be created based on identified audience preferences and/or desired emotional responses.

### System Environment

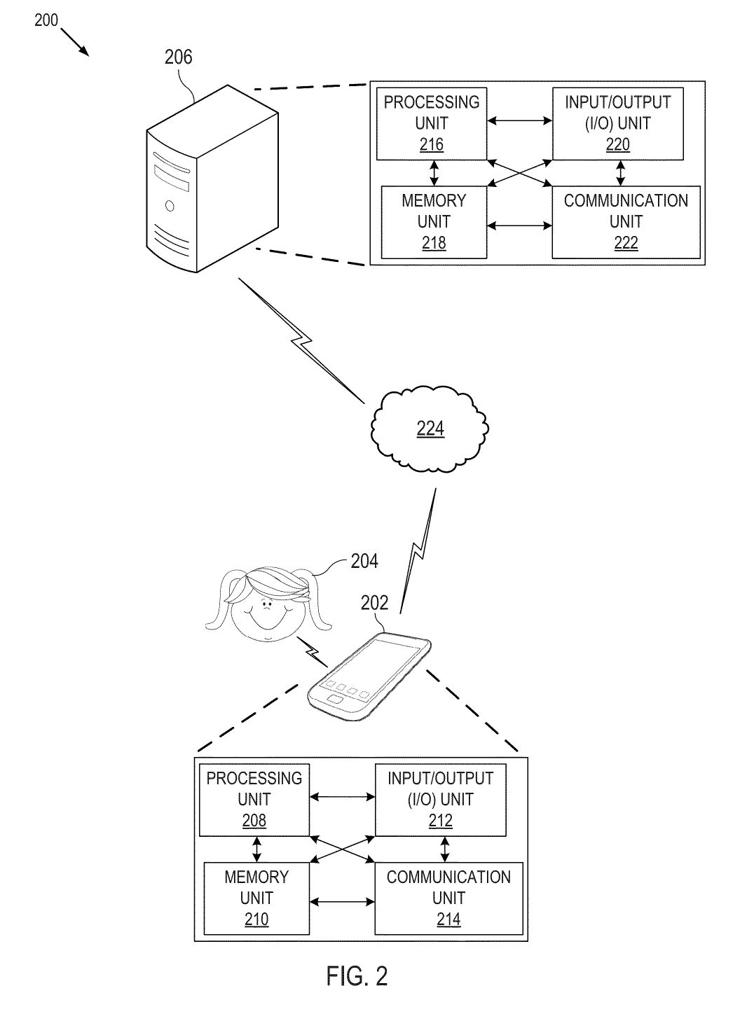

FIG. 2 illustrates an exemplary system 200 for enabling distribution and/or playback of political content, as well as for enabling capture and/or processing of emotional video and/or audio streams of users while they view the political content. As described herein, the system 200 may include a user device 202 of a user 204 and a video content server 206. In some embodiments, the user device 202 may include a handheld computing device, a smart phone, a tablet, a laptop computer, a desktop computer, a personal digital assistant (PDA), a smart watch, a wearable device, a biometric device, an implanted device, a camera, a video recorder, an audio recorder, a touchscreen, a video communication server, and/or the like. In some embodiments, the user device 202 may include a plurality of user devices as described herein.

In some embodiments, the user device 202 may include various elements of a computing environment as described herein. For example, the user device 202 may include a processing unit 208, a memory unit 210, an input/output (I/O) unit 212, and/or a communication unit 214. Each of the processing unit 208, the memory unit 210, the input/output (I/O) unit 212, and/or the communication unit 214 may include one or more subunits as described herein for performing operations associated with providing political content to the user device 204, identifying emotional cues of the user 202 during playback of political content, and/or processing of emotional cues and/or other data.

In some embodiments, the video content server 206 may include a computing device such as a mainframe server, a content server, a communication server, a laptop computer, a desktop computer, a handheld computing device, a smart phone, a smart watch, a wearable device, a touch screen, a biometric device, a video processing device, an audio processing device, and/or the like. In some embodiments, the video content server 206 may include a plurality of servers configured to communicate with one another and/or implement load-balancing techniques described herein.

In some embodiments, the video content server 206 may include various elements of a computing environment as described herein. For example, the video content server 206 may include a processing unit 216, a memory unit 218, an input/output (I/O) unit 220, and/or a communication unit 222. Each of the processing unit 216, the memory unit 218, the input/output (I/O) unit 220, and/or the communication unit 222 may include one or more subunits as described herein for performing operations associated with providing political content to the user device 204, identifying emotional cues of the user 202 during playback of political content, and/or processing of emotional cues and/or other data.

The user device 202 and/or the video content sever 206 may be communicatively coupled to one another by a network 224 as described herein. In some embodiments, the network 224 may include a plurality of networks. In some embodiments, the network 224 may include any wireless and/or wired communications network that facilitates communication (e.g., transmission and/or receipt of between the user device 202 and/or the video content server 206. For example, the one or more networks may include an Ethernet network, a cellular network, a computer network, the Internet, a wireless fidelity (Wi-Fi) network, a light fidelity (Li-Fi) network, a Bluetooth network, a radio frequency identification (RFID) network, a near-field communication (NFC) network, a laser-based network, and/or the like.

### Computing Architecture

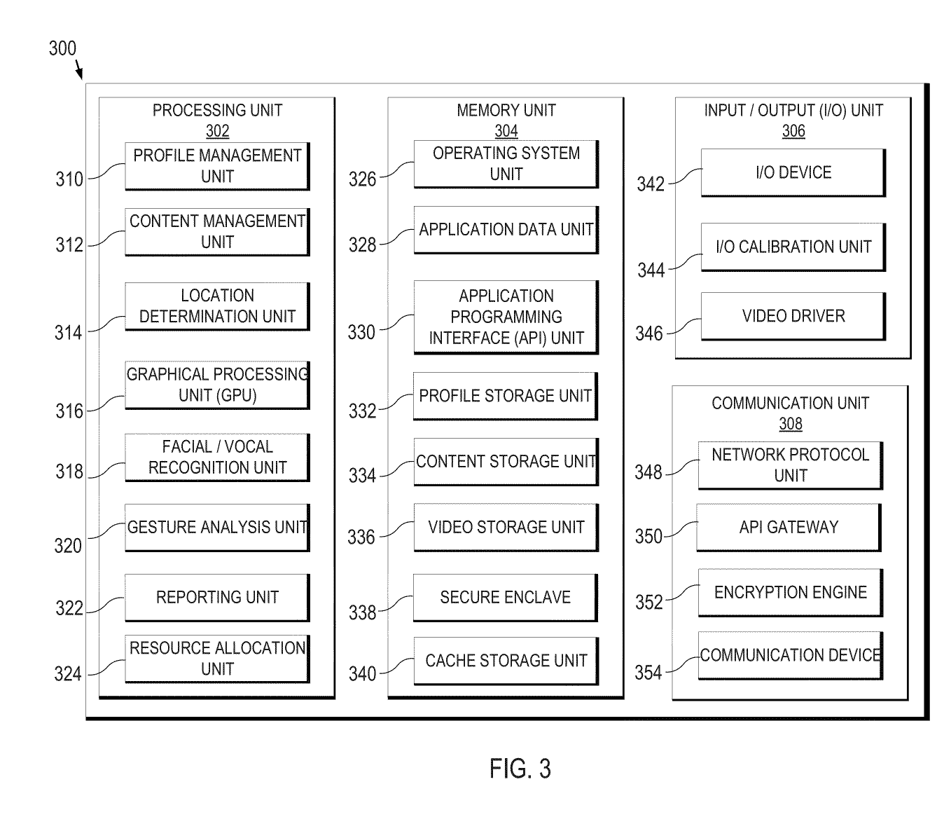

FIG. 3 illustrates an exemplary computing environment 300 for enabling delivery and/or viewing of political content and associated audio-visual processing techniques described herein. For example, the computing environment 300 may be included in and/or utilized by the user device 102 of FIG. 1, the user device 202 and/or the video content server 206 of FIG. 2, and/or any other device described herein. Additionally, any units and/or subunits described herein with reference to FIG. 3 may be included in one or more elements of FIG. 1 and/or FIG. 2 such as the user device 102, the user device 202 (e.g., the processing unit 208, the memory unit 210, the I/O unit 212, and/or the communication unit 214), and/or the video content server 206 (e.g., the processing unit 216, the memory unit 218, the I/O unit 220, and/or the communication unit 222). The computing environment 300 and/or any of its units and/or subunits described herein may include general hardware, specifically-purposed hardware, and/or software.

The computing environment 300 may include, among other elements, a processing unit 302, a memory unit 304, an input/output (I/O) unit 306, and/or a communication unit 308. As described herein, each of the processing unit 302, the memory unit 304, the I/O unit 306, and/or the communication unit 308 may include and/or refer to a plurality of respective units, subunits, and/or elements. Furthermore, each of the processing unit 302, the memory unit 304, the I/O unit 306, and/or the communication unit 308 may be operatively and/or otherwise communicatively coupled with each other so as to facilitate the political content communication and audio-visual analysis techniques described herein.

The processing unit 302 may control any of the one or more units 304, 306, 308, as well as any included subunits, elements, components, devices, and/or functions performed by the units 304, 306, 308 included in the computing environment 300. The processing unit 302 may also control any unit and/or device included in the system 200 of FIG. 2. Any actions described herein as being performed by a processor may be taken by the processing unit 302 alone and/or by the processing unit 302 in conjunction with one or more additional processors, units, subunits, elements, components, devices, and/or the like. Additionally, while only one processing unit 302 may be shown in FIG. 3, multiple processing units may be present and/or otherwise included in the computing environment 300. Thus, while instructions may be described as being executed by the processing unit 302 (and/or various subunits of the processing unit 302), the instructions may be executed simultaneously, serially, and/or by one or multiple processing units 302 in parallel.

In some embodiments, the processing unit 302 may be implemented as one or more computer processing unit (CPU) chips and/or graphical processing unit (GPU) chips and may include a hardware device capable of executing computer instructions. The processing unit 302 may execute instructions, codes, computer programs, and/or scripts. The instructions, codes, computer programs, and/or scripts may be received from and/or stored in the memory unit 304, the I/O unit 306, the communication unit 308, subunits and/or elements of the aforementioned units, other devices and/or computing environments, and/or the like. As described herein, any unit and/or subunit (e.g., element) of the computing environment 300 and/or any other computing environment may be utilized to perform any operation. Particularly, the computing environment 300 may not include a generic computing system, but instead may include a customized computing system designed to perform the various methods described herein.

In some embodiments, the processing unit 302 may include, among other elements, subunits such as a profile management unit 310, a content management unit 312, a location determination unit 314, a graphical processing unit (GPU) 316, a facial/vocal recognition unit 318, a gesture analysis unit 320, a reporting unit 322, and/or a resource allocation unit 324. Each of the aforementioned subunits of the processing unit 302 may be communicatively and/or otherwise operably coupled with each other.

The profile management unit 310 may facilitate generation, modification, analysis, transmission, and/or presentation of a user profile associated with a user. For example, the profile management unit 310 may prompt a user via a user device to register by inputting authentication credentials, personal information (e.g., an age, a gender, and/or the like), contact information (e.g., a phone number, a zip code, a mailing address, an email address, a name, and/or the like), and/or the like. The profile management unit 310 may also control and/or utilize an element of the I/O unit 306 to enable a user of the user device to take a picture of herself/himself. The profile management unit 310 may receive, process, analyze, organize, and/or otherwise transform any data received from the user and/or another computing element so as to generate a user profile of a user that includes personal information, contact information, user preferences, a photo, a video recording, an audio recording, a textual description, a virtual currency balance, a history of user activity, user preferences, settings, and/or the like.

The content management unit 312 may facilitate generation, modification, analysis, transmission, and/or presentation of media content (e.g., political content). For example, the content management unit 312 may control the audio-visual environment and/or appearance of application data during execution of various processes. Media content for which the content management unit 312 may be responsible may include advertisements, images, text, themes, audio files, video files, documents, and/or the like. The media content may be political in nature such as a video of a political campaign speech, audio of an interview with a politician, news talk radio, a campaign speech, a propaganda video, and/or the like. In some embodiments, the political content may include news, highlights, and/or top moments of a full-length piece of media content. In some embodiments, the content management unit 312 may also interface with a third-party content server and/or memory location for identifying, receiving, transmitting, and/or distributing media content to one or more users.

The location determination unit 314 may facilitate detection, generation, modification, analysis, transmission, and/or presentation of location information. Location information may include global positioning system (GPS) coordinates, an Internet protocol (IP) address, a media access control (MAC) address, geolocation information, an address, a port number, a zip code, a server number, a proxy name and/or number, device information (e.g., a serial number), and/or the like. In some embodiments, the location determination unit 314 may include various sensors, a radar, and/or other specifically-purposed hardware elements for enabling the location determination unit 314 to acquire, measure, and/or otherwise transform location information.

The GPU unit 316 may facilitate generation, modification, analysis, processing, transmission, and/or presentation of visual content (e.g., media content and/or political content described above). In some embodiments, the GPU unit 316 may be utilized to render visual content for presentation on a user device, analyze a live streaming video feed for metadata associated with a user and/or a user device responsible for generating the live video feed, and/or the like. The GPU unit 316 may also include multiple GPUs and therefore may be configured to perform and/or execute multiple processes in parallel.

The facial/vocal recognition unit 318 may facilitate recognition, analysis, and/or processing of visual content, such as a live video stream of a user's face. For example, the facial/vocal recognition unit 318 may be utilized for identifying facial features of users and/or identifying speech characteristics of a user viewing political content. In some embodiments, the facial/vocal recognition unit 318 may include GPUs and/or other processing elements so as to enable efficient analysis of video content in either series or parallel. The facial/vocal recognition unit 318 may utilize a variety of audio-visual analysis techniques such as pixel comparison, pixel value identification, voice recognition, audio sampling, video sampling, image splicing, image reconstruction, video reconstruction, audio reconstruction, and/or the like to verify an identity of a user, to verify and/or monitor subject matter of a live video feed, and/or the like.

The gesture analysis unit 320 may facilitate recognition, analysis, and/or processing of visual content, such as a live video stream of a user's face while the user is viewing political content. Similar to the facial/vocal recognition unit 318, the gesture recognition unit 320 may be utilized for identifying facial features of users and/or identifying vocal inflections of a user. Further, however, the gesture analysis unit 320 may analyze movements and/or changes in facial features and/or vocal inflection identified by the facial/vocal recognition unit 318 to identify emotional cues of a user. As used herein, emotional cues may include facial gestures such as eyebrow movements, eyeball movements, eyelid movements, ear movements, nose and/or nostril movements, lip movements, chin movements, cheek movements, forehead movements, tongue movements, teeth movements, vocal pitch shifting, vocal tone shifting, changes in word delivery speed, keywords, word count, ambient noise and/or environment noise, background noise, and/or the like. In this manner, the gesture analysis unit 320 may identify, based on identified emotional cues of a user, one or more emotions currently being experienced by the user in response to viewing political content. For example, if the gesture analysis unit 320 may determine, based on identification of emotional cues associated with a frown (e.g., a furrowed brow, a frowning smile, flared nostrils, and/or the like), that a user is unhappy and therefore disagrees with subject matter included in the political content. Predetermined emotions may include happiness, sadness, excitement, anger, fear, anger, discomfort, joy, envy, and/or the like and may also be associated with other detected user characteristics such as gender, age, demographic information, location information, and/or the like.

In some embodiments, the gesture analysis unit 320 may additionally facilitate analysis and/or processing of emotional cues and/or associated emotions identified by the gesture analysis unit 320. For example, the gesture analysis unit 320 may quantify identified emotional cues and/or intensity of identified emotional cues by assigning a numerical value (e.g., an alphanumeric character) to each identified emotional cue. In some embodiments, numerical values of identified emotional cues may be weighted and/or assigned a grade (e.g., an alphanumeric label such as A, B, C, D, F, and/or the like) associated with a perceived value and/or quality (e.g., an emotion) by the gesture analysis unit 320. In addition to assigning numerical values of identified emotional cues, the gesture analysis unit 320 may quantify and/or otherwise utilize other factors associated with political content such as a time duration of the political content, an intensity of an identified emotional cue, and/or the like. For example, the gesture analysis unit 320 may assign a larger weight to an identified emotional cue that occurred during a user's viewing of political content lasting one minute than an identified emotional cue that occurred during a user's viewing of political content lasting thirty seconds. The gesture analysis unit 320 may determine appropriate numerical values based on a predetermined table of predefined emotional cues associated with emotions and/or a variety of factors associated with political content such as time duration, a frequency, intensity, and/or duration of an identified emotional cue, and/or the like.

The gesture analysis unit 320 may also facilitate the collection, receipt, processing, analysis, and/or transformation of user input received from user devices of users viewing political content. For example, the gesture analysis unit 320 may facilitate a user viewing political content to provide feedback associated with emotions currently being experienced by the user. This feedback may be received, processed, weighted, and/or transformed by the gesture analysis unit 320.

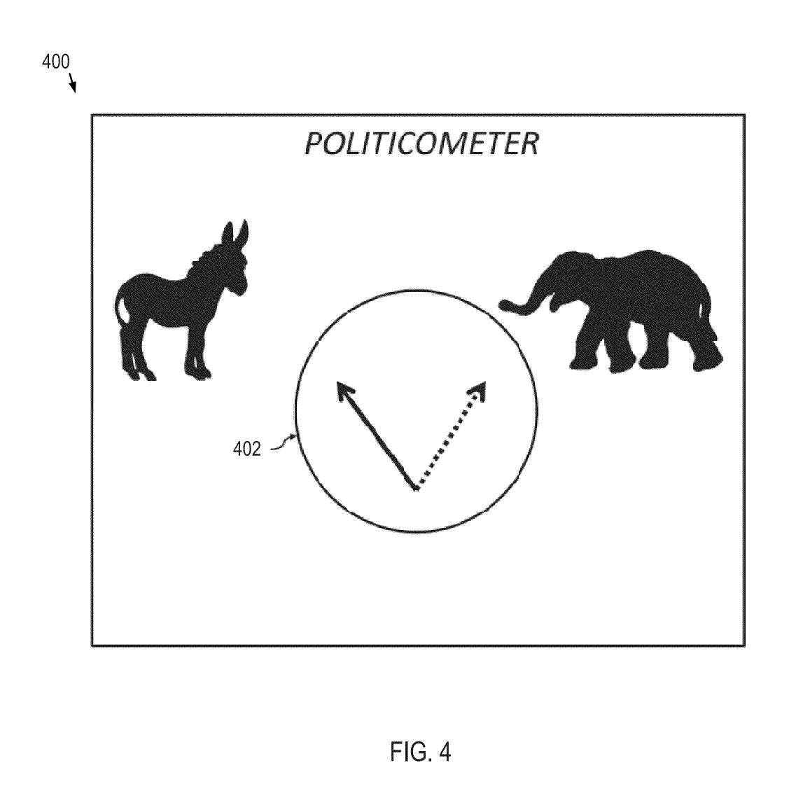

The reporting unit 322 may facilitate the determination, generation, and/or presentation of reports of data associated with a user's detected emotional responses to political content. For example, the reporting unit 322 may receive information associated with a user's detected emotional responses from the gesture analysis unit 320. Based at least in part on information associated with a user's detected emotional responses received from the gesture analysis unit 320, as well as any information included in one or more user profiles (e.g., demographic information, location information, personal information, and/or the like), the reporting unit 322 may produce one or more pieces of information (e.g., graphics, charts, analytics, facts, statistics, and/or the like) that communicate how political content is being and/or has been received by a user and/or an audience. For example, the reporting unit 322 may determine, by generating a relevance score associated with political content, how relevant the political content may be to a particular user, user type, political party, audience demographic, and/or the like. Additionally, the reporting unit 322 may be responsible for summarizing how well political content was received by a particular audience based on emotional responses of audience members as described herein and/or illustrated in FIGS. 4-6.

The resource allocation unit 324 may facilitate the determination, monitoring, analysis, and/or allocation of computing resources throughout the computing environment 300 and/or other computing environments. For example, the computing environment 300 may facilitate a high volume of (e.g., multiple) video streaming connections between a large number of supported users and/or associated user devices and a video content server so that political content, as well as live video feeds of users viewing the political content, may be communicated between user devices and the video content server. As such, computing resources of the computing environment 300 utilized by the processing unit 302, the memory unit 304, the I/O unit, and/or the communication unit 308 (and/or any subunit of the aforementioned units) such as processing power, data storage space, network bandwidth, and/or the like may be in high demand at various times during operation. Accordingly, the resource allocation unit 324 may be configured to manage the allocation of various computing resources as they are required by particular units and/or subunits of the computing environment 300 and/or other computing environments. In some embodiments, the resource allocation unit 324 may include sensors and/or other specially-purposed hardware for monitoring performance of each unit and/or subunit of the computing environment 300, as well as hardware for responding to the computing resource needs of each unit and/or subunit. In some embodiments, the resource allocation unit 324 may utilize computing resources of a second computing environment separate and distinct from the computing environment 300 to facilitate a desired operation.

For example, the resource allocation unit 324 may determine a number of simultaneous video streaming connections, a number of incoming requests for establishing video streaming connections, a number of users to receive political content, and/or the like. The resource allocation unit 324 may then determine that the number of simultaneous video streaming connections and/or incoming requests for receiving political content meets and/or exceeds a predetermined threshold value. Based on this determination, the resource allocation unit 324 may determine an amount of additional computing resources (e.g., processing power, storage space of a particular non-transitory computer-readable memory medium, network bandwidth, and/or the like) required by the processing unit 302, the memory unit 304, the I/O unit 306, the communication unit 308, and/or any subunit of the aforementioned units for enabling safe and efficient operation of the computing environment 300 while supporting the number of simultaneous video streaming connections and/or incoming requests for receiving political content. The resource allocation unit 324 may then retrieve, transmit, control, allocate, and/or otherwise distribute determined amount(s) of computing resources to each element (e.g., unit and/or subunit) of the computing environment 300 and/or another computing environment.

In some embodiments, factors affecting the allocation of computing resources by the resource allocation unit 324 may include a volume of video streaming connections and/or other content delivery channel connections, a duration of time during which computing resources are required by one or more elements of the computing environment 300, and/or the like. In some embodiments, computing resources may be allocated to and/or distributed amongst a plurality of second computing environments included in the computing environment 300 based on one or more factors mentioned above. In some embodiments, the allocation of computing resources of the resource allocation unit 324 may include the resource allocation unit 324 flipping a switch, adjusting processing power, adjusting memory size, partitioning a memory element, transmitting data, controlling one or more input and/or output devices, modifying various communication protocols, and/or the like. In some embodiments, the resource allocation unit 324 may facilitate utilization of parallel processing techniques such as dedicating a plurality of GPUs included in the processing unit 302 for processing a high-quality video stream of a video streaming connection and/or distribution of political content between multiple units and/or subunits of the computing environment 300 and/or other computing environments.

In some embodiments, the memory unit 304 may be utilized for storing, recalling, receiving, transmitting, and/or accessing various files and/or information during operation of the computing environment 300. The memory unit 304 may include various types of data storage media such as solid state storage media, hard disk storage media, and/or the like. The memory unit 304 may include dedicated hardware elements such as hard drives and/or servers, as well as software elements such as cloud-based storage drives. For example, the memory unit 304 may include various subunits such as an operating system unit 326, an application data unit 328, an application programming interface (API) unit 330, a profile storage unit 332, a content storage unit 334, a video storage unit 336, a secure enclave 338, and/or a cache storage unit 340.

The memory unit 304 and/or any of its subunits described herein may include random access memory (RAM), read only memory (ROM), and/or various forms of secondary storage. RAM may be used to store volatile data and/or to store instructions that may be executed by the processing unit 302. For example, the data stored may be a command, a current operating state of the computing environment 300, an intended operating state of the computing environment 300, and/or the like. As a further example, data stored in the memory unit 304 may include instructions related to various methods and/or functionalities described herein. ROM may be a non-volatile memory device that may have a smaller memory capacity than the memory capacity of a secondary storage. ROM may be used to store instructions and/or data that may be read during execution of computer instructions. In some embodiments, access to both RAM and ROM may be faster than access to secondary storage. Secondary storage may be comprised of one or more disk drives and/or tape drives and may be used for non-volatile storage of data or as an over-flow data storage device if RAM is not large enough to hold all working data. Secondary storage may be used to store programs that may be loaded into RAM when such programs are selected for execution. In some embodiments, the memory unit 304 may include one or more databases for storing any data described herein. Additionally or alternatively, one or more secondary databases located remotely from the computing environment 300 may be utilized and/or accessed by the memory unit 304.

The operating system unit 326 may facilitate deployment, storage, access, execution, and/or utilization of an operating system utilized by the computing environment 300 and/or any other computing environment described herein (e.g., a user device). In some embodiments, the operating system may include various hardware and/or software elements that serve as a structural framework for enabling the processing unit 302 to execute various operations described herein. The operating system unit 326 may further store various pieces of information and/or data associated with operation of the operating system and/or the computing environment 300 as a whole, such as a status of computing resources (e.g., processing power, memory availability, resource utilization, and/or the like), runtime information, modules to direct execution of operations described herein, user permissions, security credentials, and/or the like.

The application data unit 328 may facilitate deployment, storage, access, execution, and/or utilization of an application utilized by the computing environment 300 and/or any other computing environment described herein (e.g., a user device). For example, users may be required to download, access, and/or otherwise utilize a software application on a user device such as a smartphone in order for various operations described herein to be performed. As such, the application data unit 328 may store any information and/or data associated with the application. Information included in the application data unit 328 may enable a user to execute various operations described herein. The application data unit 328 may further store various pieces of information and/or data associated with operation of the application and/or the computing environment 300 as a whole, such as a status of computing resources (e.g., processing power, memory availability, resource utilization, and/or the like), runtime information, modules to direct execution of operations described herein, user permissions, security credentials, and/or the like.

The API unit 330 may facilitate deployment, storage, access, execution, and/or utilization of information associated with APIs of the computing environment 300 and/or any other computing environment described herein (e.g., a user device). For example, computing environment 300 may include one or more APIs for enabling various devices, applications, and/or computing environments to communicate with each other and/or utilize the same data. Accordingly, the API unit 330 may include API databases containing information that may be accessed and/or utilized by applications and/or operating systems of other devices and/or computing environments. In some embodiments, each API database may be associated with a customized physical circuit included in the memory unit 304 and/or the API unit 330. Additionally, each API database may be public and/or private, and so authentication credentials may be required to access information in an API database.

The profile storage unit 332 may facilitate deployment, storage, access, and/or utilization of information associated with user profiles of users by the computing environment 300 and/or any other computing environment described herein (e.g., a user device). For example, the profile storage unit 332 may store one or more user's contact information, authentication credentials, user preferences, user history of behavior, personal information, location information, received input and/or sensor data, and/or metadata. In some embodiments, the profile storage unit 332 may communicate with the profile management unit 310 to receive and/or transmit information associated with a user's profile.

The content storage unit 334 may facilitate deployment, storage, access, and/or utilization of information associated with requested content by the computing environment 300 and/or any other computing environment described herein (e.g., a user device). For example, the content storage unit 334 may store one or more images, text, videos, audio content, advertisements, and/or metadata (e.g., political content) to be presented to a user during operations described herein. The content storage unit 334 may store political content that may be recalled by the features unit 322 during operations described herein. In some embodiments, the political content stored in the content storage unit 334 may be associated with numerical values corresponding to predetermined emotions and/or emotional cues. In some embodiments, the content storage unit 334 may communicate with the content management unit 312 to receive and/or transmit content files.

The video storage unit 336 may facilitate deployment, storage, access, analysis, and/or utilization of video content by the computing environment 300 and/or any other computing environment described herein (e.g., a user device). For example, the video storage unit 336 may store one or more live video feeds of a user's face transmitted during a video streaming connection (e.g., while the user views political content), received user input and/or sensor data, and/or the like. Live video feeds of each user's face during playback of political content may be stored by the video storage unit 336 so that the live video feeds may be analyzed by various components of the computing environment 300 both in real time and at a time after receipt of the live video feeds. In some embodiments, the video storage unit 336 may communicate with the GPUs 316, the facial/vocal recognition unit 318, the gesture analysis unit 320, and/or the features unit 322 to facilitate analysis of any stored video information. In some embodiments, video content may include audio, images, text, video, political content, and/or any other media content.

The secure enclave 338 may facilitate secure storage of data. In some embodiments, the secure enclave 338 may include a partitioned portion of storage media included in the memory unit 304 that is protected by various security measures. For example, the secure enclave 338 may be hardware secured. In other embodiments, the secure enclave 338 may include one or more firewalls, encryption mechanisms, and/or other security-based protocols. Authentication credentials of a user may be required prior to providing the user access to data stored within the secure enclave 338.

The cache storage unit 340 may facilitate short-term deployment, storage, access, analysis, and/or utilization of data. For example, the cache storage unit 348 may serve as a short-term storage location for data so that the data stored in the cache storage unit 348 may be accessed quickly. In some embodiments, the cache storage unit 340 may include RAM and/or other storage media types that enable quick recall of stored data. The cache storage unit 340 may included a partitioned portion of storage media included in the memory unit 304.

As described herein, the memory unit 304 and its associated elements may store any suitable information. Any aspect of the memory unit 304 may comprise any collection and arrangement of volatile and/or non-volatile components suitable for storing data. For example, the memory unit 304 may comprise random access memory (RAM) devices, read only memory (ROM) devices, magnetic storage devices, optical storage devices, and/or any other suitable data storage devices. In particular embodiments, the memory unit 304 may represent, in part, computer-readable storage media on which computer instructions and/or logic are encoded. The memory unit 304 may represent any number of memory components within, local to, and/or accessible by a processor.

The I/O unit 306 may include hardware and/or software elements for enabling the computing environment 300 to receive, transmit, and/or present information. For example, elements of the I/O unit 306 may be used to receive user input from a user via a user device, present a live video feed to the user via the user device, and/or the like. In this manner, the I/O unit 306 may enable the computing environment 300 to interface with a human user. As described herein, the I/O unit 306 may include subunits such as an I/O device 342, an I/O calibration unit 344, and/or video driver 346.

The I/O device 342 may facilitate the receipt, transmission, processing, presentation, display, input, and/or output of information as a result of executed processes described herein. In some embodiments, the I/O device 342 may include a plurality of I/O devices. In some embodiments, the I/O device 342 may include one or more elements of a user device, a computing system, a server, and/or a similar device.

The I/O device 342 may include a variety of elements that enable a user to interface with the computing environment 300. For example, the I/O device 342 may include a keyboard, a touchscreen, a touchscreen sensor array, a mouse, a stylus, a button, a sensor, a depth sensor, a tactile input element, a location sensor, a biometric scanner, a laser, a microphone, a camera, and/or another element for receiving and/or collecting input from a user and/or information associated with the user and/or the user's environment. Additionally and/or alternatively, the I/O device 342 may include a display, a screen, a projector, a sensor, a vibration mechanism, a light emitting diode (LED), a speaker, a radio frequency identification (RFID) scanner, and/or another element for presenting and/or otherwise outputting data to a user. In some embodiments, the I/O device 342 may communicate with one or more elements of the processing unit 302 and/or the memory unit 304 to execute operations described herein. For example, the I/O device 342 may include a display, which may utilize the GPU 316 to present political content stored in the video storage unit 336 to a user of a user device. The I/O device 342 may also be used to capture a live video feed of the user during playback of the political content.

The I/O calibration unit 344 may facilitate the calibration of the I/O device 342. For example, the I/O calibration unit 344 may detect and/or determine one or more settings of the I/O device 342, and then adjust and/or modify settings so that the I/O device 342 may operate more efficiently.

In some embodiments, the I/O calibration unit 344 may utilize a video driver 346 (or multiple video drivers) to calibrate the I/O device 342. For example, the video driver 346 may be installed on a user device so that the user device may recognize and/or integrate with the I/O device 342, thereby enabling video content to be displayed, received, generated, and/or the like. In some embodiments, the I/O device 342 may be calibrated by the I/O calibration unit 344 by based on information included in the video driver 346.

The communication unit 308 may facilitate establishment, maintenance, monitoring, and/or termination of communications (e.g., a video streaming connection and/or distribution of political content) between the computing environment 300 and other devices such as user devices, other computing environments, third party server systems, and/or the like. The communication unit 308 may further enable communication between various elements (e.g., units and/or subunits) of the computing environment 300. In some embodiments, the communication unit 308 may include a network protocol unit 348, an API gateway 350, an encryption engine 352, and/or a communication device 354. The communication unit 308 may include hardware and/or software elements. In some embodiments, the communication unit 308 may be utilized to transmit and/or receive political content and/or live video feeds of a user's face.

The network protocol unit 348 may facilitate establishment, maintenance, and/or termination of a communication connection between the computing environment 300 and another device by way of a network. For example, the network protocol unit 348 may detect and/or define a communication protocol required by a particular network and/or network type. Communication protocols utilized by the network protocol unit 348 may include Wi-Fi protocols, Li-Fi protocols, cellular data network protocols, Bluetooth® protocols, WiMAX protocols, Ethernet protocols, powerline communication (PLC) protocols, Voice over Internet Protocol (VoIP), and/or the like. In some embodiments, facilitation of communication between the computing environment 300 and any other device, as well as any element internal to the computing environment 300, may include transforming and/or translating data from being compatible with a first communication protocol to being compatible with a second communication protocol. In some embodiments, the network protocol unit 348 may determine and/or monitor an amount of data traffic to consequently determine which particular network protocol is to be used for establishing a video streaming connection, distributing political content, transmitting data, and/or performing other operations described herein.

The API gateway 350 may facilitate the enablement of other devices and/or computing environments to access the API unit 330 of the memory unit 304 of the computing environment 300. For example, a user device may access the API unit 330 via the API gateway 350. In some embodiments, the API gateway 350 may be required to validate user credentials associated with a user of a user device prior to providing access to the API unit 330 to the user. The API gateway 350 may include instructions for enabling the computing environment 300 to communicate with another device.

The encryption engine 352 may facilitate translation, encryption, encoding, decryption, and/or decoding of information received, transmitted, and/or stored by the computing environment 300. Using the encryption engine, each transmission of data may be encrypted, encoded, and/or translated for security reasons, and any received data may be encrypted, encoded, and/or translated prior to its processing and/or storage. In some embodiments, the encryption engine 352 may generate an encryption key, an encoding key, a translation key, and/or the like, which may be transmitted along with any data content.

The communication device 354 may include a variety of hardware and/or software specifically purposed to enable communication between the computing environment 300 and another device, as well as communication between elements of the computing environment 300. In some embodiments, the communication device 354 may include one or more radio transceivers, chips, analog front end (AFE) units, antennas, processing units, memory, other logic, and/or other components to implement communication protocols (wired or wireless) and related functionality for facilitating communication between the computing environment 300 and any other device. Additionally and/or alternatively, the communication device 354 may include a modem, a modem bank, an Ethernet device such as a router or switch, a universal serial bus (USB) interface device, a serial interface, a token ring device, a fiber distributed data interface (FDDI) device, a wireless local area network (WLAN) device and/or device component, a radio transceiver device such as code division multiple access (CDMA) device, a global system for mobile communications (GSM) radio transceiver device, a universal mobile telecommunications system (UMTS) radio transceiver device, a long term evolution (LTE) radio transceiver device, a worldwide interoperability for microwave access (WiMAX) device, and/or another device used for communication purposes.

It is contemplated that the computing elements be provided according to the structures disclosed herein may be included in integrated circuits of any type to which their use commends them, such as ROMs, RAM (random access memory) such as DRAM (dynamic RAM), and video RAM (VRAM), PROMs (programmable ROM), EPROM (erasable PROM), EEPROM (electrically erasable PROM), EAROM (electrically alterable ROM), caches, and other memories, and to microprocessors and microcomputers in all circuits including ALUs (arithmetic logic units), control decoders, stacks, registers, input/output (I/O) circuits, counters, general purpose microcomputers, RISC (reduced instruction set computing), CISC (complex instruction set computing) and VLIW (very long instruction word) processors, and to analog integrated circuits such as digital to analog converters (DACs) and analog to digital converters (ADCs). ASICS, PLAs, PALs, gate arrays and specialized processors such as digital signal processors (DSP), graphics system processors (GSP), synchronous vector processors (SVP), and image system processors (ISP) all represent sites of application of the principles and structures disclosed herein.

Implementation is contemplated in discrete components or fully integrated circuits in silicon, gallium arsenide, or other electronic materials families, as well as in other technology-based forms and embodiments. It should be understood that various embodiments of the invention can employ or be embodied in hardware, software, microcoded firmware, or any combination thereof. When an embodiment is embodied, at least in part, in software, the software may be stored in a non-volatile, machine-readable medium.

Networked computing environment such as those provided by a communications server may include, but are not limited to, computing grid systems, distributed computing environments, cloud computing environment, etc. Such networked computing environments include hardware and software infrastructures configured to form a virtual organization comprised of multiple resources which may be in geographically disperse locations.

### System Operation

To begin operation of embodiments described herein, a user of a user device may download an application associated with performing operations described herein to a user device. For example, the user may download the application from an application store or a digital library of applications available for download via an online network. In some embodiments, downloading the application may include transmitting application data from the application data unit 328 of the computing environment 300 to the user device. Alternatively, the user may access an application associated with performing operations described herein using the Internet, a web server, and/or another content distribution method.

Upon download and installation of the application on the user device, the user may select and open the application. The application may then prompt the user via the user device to register and create a user profile. The user may input authentication credentials such as a username and password, an email address, contact information, personal information (e.g., an age, a gender, and/or the like), user preferences, and/or other information as part of the user registration process. This inputted information, as well as any other information described herein, may be inputted by the user of the user device and/or outputted to the user of the user device using the I/O device 342. Once inputted, the information may be received by the user device and subsequently transmitted from the user device to the profile management unit 310 and/or the profile storage unit 332, which receive(s) the inputted information.

In some embodiments, registration of the user may include transmitting a text message (and/or another message type) requesting the user to confirm registration and/or any inputted information to be included in the user profile from the profile management unit 310 to the user device. The user may confirm registration via the user device, and an acknowledgement may be transmitted from the user device to the profile management unit 310, which receives the acknowledgement and generates the user profile based on the inputted information.

After registration is complete, the user may utilize the I/O device 342 to capture an picture of the her or his face. This picture, once generated, may be included in the user profile of the user for identification of the user. In some embodiments, the user may capture an image of her or his face using a camera on the user device (e.g., a smartphone camera, a sensor, and/or the like). In other embodiments, the user may simply select and/or upload an existing image file using the user device. The user may further be enabled to modify the image by applying a filter, cropping the image, changing the color and/or size of the image, and/or the like. Accordingly, the user device may receive the image (and/or image file) and transmit the image to the computing environment 300 for processing. Alternatively, the image may be processed locally on the user device.

In some embodiments, the image may be received and analyzed (e.g., processed) by the facial/vocal recognition unit 318. In some embodiments, the facial/vocal recognition unit 318 may utilize the GPU 316 for analysis of the image. The facial/vocal recognition unit 318 may process the image of the user's face to identify human facial features. Various techniques may be deployed during processing of the image to identify facial features, such as pixel color value comparison. For example, the facial/vocal recognition unit 318 may identify objects of interest and/or emotional cues in the image based on a comparison of pixel color values and/or locations in the image. Each identified object of interest may be counted and compared to predetermined and/or otherwise known facial features included in a database using the facial/vocal recognition unit 318. The facial/vocal recognition unit 318 may determine at least a partial match (e.g., a partial match that meets and/or exceeds a predetermined threshold of confidence) between an identified object of interest and a known facial feature to thereby confirm that the object of interest in the image is indeed a facial feature of the user. Based on a number and/or a location of identified facial features in the image, the facial/vocal recognition unit 318 may determine that the image is a picture of the user's face (as opposed to other subject matter, inappropriate subject matter, and/or the like). In this manner, the facial/vocal recognition unit 318 may provide a layer of security by ensuring that the image included in a user's profile is a picture of the user's face.

Once the facial/vocal recognition unit 318 determines that the image is an acceptable picture of the user's face, the computing environment 300 may store the image in the profile storage unit 332 so that the image may be included in the user's user profile. In some embodiments, the image included in the user's user profile may be utilized by the facial/vocal recognition unit 318 and/or the gesture analysis unit 320 as a reference image from which facial feature movements may be calculated and/or otherwise determined. Conversely, when the facial/vocal recognition unit 318 determines that the image is not an acceptable picture of the user's face (e.g., the image is determined to not be a picture of the user's face), the facial/vocal recognition unit 318 may generate a notification to be sent to and/or displayed by the user device for presentation to the user that explains that the provided image is unacceptable. The user may then repeat the process of capturing an image of her or his face and/or resubmitting an existing image file using the user device. In some embodiments, the user may be prohibited by the computing environment 300 from continuing application use until an image of the user's face is determined by the facial/vocal recognition unit 318 to be legitimate.

As stated above, the image may be processed by the facial/vocal recognition unit 318 on the user device. In other embodiments, the image may be transmitted to another device (e.g., computing environment 300, a third party server, and/or the like) for processing. In some embodiments, any facial features of the user identified by the facial/vocal recognition unit 318 may be stored in the profile storage unit 332 for later recall during analysis of video content of the user.

After registration and generation of the user's profile is complete, the user may initiate, using the user device, a request to receive political content. For example, the user may initiate a request to view a video, listen to audio, and/or otherwise consume media content associated with political subject matter using the application. In some embodiments, the request may be initiated by the user using the I/O device 342 (e.g., via a user device). For example, the user may perform a gesture recognized by the I/O device 342 (and/or the gesture analysis unit 320), such as holding down a predetermined number of fingers on a touchscreen, selecting a “play” function of political content in the application, and/or the like to initiate the request.

After initiation, the request may be transmitted to and/or received by the communication unit 308 of the computing environment 300. The request may include connection information such as wireless band information, encryption information, wireless channel information, communication protocols and/or standards, and/or other information required for establishing a communication connection between the user device of the user and the computing environment 300 (e.g., a video content server).

The communication unit 308 may then establish a communication connection between the user device of the user the video content server. In some embodiments, establishing the communication connection may include receiving and/or determining one or more communication protocols (e.g., network protocols) using the network protocol unit 348. For example, the video communication connection may be established by the communication unit 308 using communication protocols included in the request to establish the communication connection submitted by the user. In some embodiments, the communication unit 308 may establish a plurality of communication connections simultaneously and/or otherwise in parallel with a plurality of user devices who are to receive the political content.

In some embodiments, the established communication connection between the user device of the user and the video content server may be configured by the communication unit 308 to last for a predetermined time duration. For example, according to rules defined by the application and/or stored in the application data unit 328, the communication connection for distributing political content to one or more user device may be established for a predetermined amount of time. Alternatively, the communication connection may last indefinitely and/or until a user decides to terminate the communication connection.

Once the communication connection has been established by the communication unit 308, the video content server may transmit political content via the communication connection to the user device (and/or via a plurality of communication connections to respective user devices). In some embodiments, transmitting political content to the user device may include transmitting a live stream of video content, audio content, a content file, a text file, an image and/or the like. The political content may be presented to the user via the user device, which may utilize the I/O device 342 as described herein.

During playback of the political content (e.g., while the user views the political content), the user may utilize the I/O device 342 (e.g., a camera and a microphone, a sensor, and/or the like) included in the user device to capture a live video feed of the user's face and/or voice. In some embodiments, the live video feed of the user and/or the live audio feed of the user captured by the user device during playback of the political content may be transmitted from the user device to the video content server for processing as described herein. Alternatively, the live video feed and/or live audio feed of the user may be processed as described herein on the user device.

The live video feed and/or the live audio feed of the users' face and/or voice may be transmitted to and/or received by the computing environment 300 for processing. For example, the GPU 316, the facial/vocal recognition unit 318, and/or the gesture analysis unit 320 may analyze the live video feed and/or the live audio feed. In some embodiments, the GPU 316, the facial/vocal recognition unit 318, and/or the gesture analysis unit 320 may analyze the live video feed and/or the live audio feed to determine which emotions are being communicated by the user during playback of the political content by identifying emotional cues in the video feed and/or the live audio feed as described herein.

Similar to the processes outlined above that are associated with confirming the captured image of the user's face to be included in the user's profile indeed includes only the user's face, the GPU 316 and/or the facial/vocal recognition unit 318 may analyze the live video feed and/or the live audio feed of the user's face during playback of the political content to determine that the live video feed of the user's face being transmitted from the user device to the video content server (e.g., the computing environment 300) by way of the communication connection include only the user's face. For example, the facial/vocal recognition unit 318 may employ various pixel comparison techniques described herein to identify facial features in the live video feed of the user to determine whether the live video feeds are indeed appropriate (e.g., do not contain any inappropriate subject matter).

Additionally, the facial/vocal recognition unit 318 may analyze the captured audio feed of the user. Analysis of captured audio may include vocal recognition techniques so that the identity of the user may be confirmed. Further, the facial/vocal recognition unit 318 may analyze captured audio of each user to identify keywords, changes in vocal pitch and/or vocal tone, and/or other objects of interest (e.g., emotional cues). Particularly, identifying objects of interest such as changes in vocal pitch and/or vocal tone or keywords in a user's speech in this manner may enable the facial/vocal recognition unit 318 to determine whether that user is laughing, crying, yelling, screaming, using sarcasm, and/or is otherwise displaying a particular emotion (e.g., a positive emotion and/or a negative emotion) in response to viewing the political content.

If the facial/vocal recognition unit 318 determines any content of the live video feed and/or the live audio feed is inappropriate based on its analysis of the live video feed and/or the live audio feed, then the communication unit 308 may terminate the communication connection. For example, if the facial/vocal recognition unit 318 determines that the user's face has left the frame being captured by a video camera and/or a sensor on the user device (e.g., the I/O device 342), the communication unit 308 may terminate and/or otherwise suspend the communication connection, distribution of the political content, and/or transmission of the live video feed and/or the live audio feed.

Accordingly, any emotional cues identified by the facial/vocal recognition unit 318 (e.g., facial features, a vocal identity, and/or the like) may be analyzed by the gesture analysis unit 320. In some embodiments, the gesture analysis unit 320 may compare identified objects of interest (e.g., emotional cues) over time. For example, the gesture analysis unit 320 may determine an amount of movement of one or more facial features based on pixel locations of identified facial features, a change in color of one or more facial features, a change in vocal inflection, vocal pitch, vocal phrasing, rate of speech delivery, and/or vocal tone, and/or the like. The gesture analysis unit 320 may, based on the analysis of the live video feed and/or the live audio feed, determine one or more gestures performed by the user and/or the second user. For example, based on determining that both corners of the user's lips moved upwards in relation to other identified facial features, the gesture analysis unit 320 may determine that the user is smiling. In some embodiments, the gesture analysis unit 320 may determine a gesture has been performed by a user based on a combination of factors such as multiple facial feature movements, vocal inflections, spoken keywords, and/or the like. In some embodiments, the gesture analysis unit 320 may determine a gesture has been performed based on determining at least a partial match between identified facial feature movements, vocal changes, and/or the like and a predetermined gesture patterns stored in a database (e.g., stored in memory unit 304).

Each identified gesture (e.g., emotional cue) may next be assigned a numerical value associated with a predetermined emotion by the gesture analysis unit 320. For example, an identified smile gesture may be assigned a positive numerical value, whereas an identified frown gesture may be assigned a negative numerical value. Additionally and/or alternatively, the gesture analysis unit 320 may assign different weights to the numerical values of different identified gestures. For example, a numerical value associated with an identified large smile gesture might be weighted by the gesture analysis unit 320 more heavily than a numerical value associated with an identified small smirk gesture. As described herein, each numerical value associated with identified gestures (e.g., emotional cues) may correspond to a particular emotion.

In some embodiments, the reporting unit 322 may utilize numerical values associated with one or more identified emotions (e.g., emotional cues, and/or the like) determined by the facial/vocal recognition unit 318 and/or the gesture analysis unit 320 to generate a variety of statistics, analytics, summaries, and/or other information associated with how the political content has been received by a user and/or an audience of users. For example, the reporting unit 322 may generate a relevance score based on numerical values associated with each identified emotional cue (and/or any other identified object of interest). The relevance score may correspond to a level of relevance of the political content to a particular user, a user type, an audience, and/or the like. In this manner, the relevance score may communicate how well and/or how poorly political content was received (and/or is expected to be received) by a user and/or an audience based on identified emotional responses of the user and/or the audience as a whole.

Additionally, the reporting unit 322 may generate emotional scores for each emotion of the user and/or an audience of users identified by the facial/vocal recognition unit 318 and/or the gesture analysis unit 320. In some embodiments, the reporting unit 322 may also identify one or more emotional responses (and/or numerical values associated with an identified emotional response) at a point in time during playback of the political content. In this manner, the reporting unit 322 may enable a user to determine which moments in the political content evoked particular emotions of a user and/or an audience.

In some embodiments, the reporting unit 322 may present a generated report to the user via the user device. The report may include an email, text, an image, a graphic, an infographic, a score, a chart, and/or the like. The user may be enabled to filter various pieces of information from the report so that the user may view only a desired subset of information included in the report. In some embodiments, generating the report may include transmitting the report to one or more user devices, computing environments, and/or the like.

In some embodiments, the user (e.g., the users described herein, an administrator, and/or the like) may be enabled to add, delete, and/or modify various elements for the processing unit 302 and/or the memory unit 304 to identify and/or store, respectively. For example, a user may add a new emotion to be detected by the gesture analysis unit 320 through analysis of the live audio and/or visual feed of the user during playback of political content. The computing environment 300 may also be enabled, through machine learning techniques and/or database updates, to learn, modify, and/or refine its database of known and/or predetermined emotions, gestures, facial features, objects of interest, emotional cues, political determinations and/or affiliations, and/or the like. Additionally, the computing environment 300 (e.g., the gesture analysis unit 320 and/or the reporting unit unit 322) may update its numerical valuing and/or weighting techniques based on popularity, frequency of use, and/or other factors associated with the aforementioned database of known and/or predetermined emotions, gestures, facial features, objects of interest, emotional cues, and/or the like.

In some embodiments, the application data stored in the application data unit 328 and/or the API unit 330 may enable the application described herein to interface with social media applications. For example, a user may be enabled to import contact information and/or profile information from a social media application so that the user may receive more relevant political content and/or a more tailored application experience.

In some embodiments, the I/O device 342 may include and/or utilize depth sensors that may determine depth information for each pixel and/or a sub-sampled set of pixels in a live video stream. Depth information captured by depth sensors may be used to distinguish which pixels are to be associated with foreground objects (e.g., the users) and which pixels are to be associated with the background, so the facial/vocal recognition unit 318 and/or the gesture analysis unit 320 may be aware of which pixels represent the user's face and which pixels represent a background. In this manner, the facial/vocal recognition unit 318 may identify and/or otherwise utilize contextual information included in a background image of the live video feed and/or the live audio feed (e.g., landmarks, environmental and/or ambient sounds, and/or other environmental variables) to determine an emotional response being expressed by the user during playback of political content.

Additionally, the I/O device 342 may retrieve, receive, and/or collect sensor data associated with user movements in response to playback of political content. In this manner, the facial/vocal recognition unit 318 may identify and/or otherwise utilize movement data (e.g., sensor data) associated with user movements taken in response to viewing political content. For example, the facial/vocal recognition unit 318 may identify, using sensor data associated with movements of a user, that the user is performing an activity (e.g., running, walking, jumping, shaking, biking, flying, driving, and/or the like). This determination may then be utilized by the gesture analysis unit 322 to determine one or more emotional cues associated with the activity.

In some embodiments, location information associated with a user device of the user may be determined by the location determination unit 314. This location information may be utilized by the facial/vocal recognition unit 318, the gesture analysis unit 320, and/or the reporting unit 322 to identify one or more emotional cues, demographic information, and/or the like of the user.

In some embodiments, the live video feed and/or the live audio feed of the user during playback of the political content may be transmitted to another computing device for processing. For example, the communication unit 308 may transmit a live video feed of the user's face during playback of the political content, sensor data, and/or location information that is received from a user device to a third party video processing engine (e.g., a decision engine) for processing. The communication unit 308 may then receive processed video content and/or results of processing such identification of a location of a user device, identification of (e.g., a numerical value associated with) an emotion of a user identified based on an analysis of video content and/or a user history of the user, and/or the like.

### User Interface Descriptions

FIG. 4 shows an exemplary user interface 400 of a generated report associated with political content as described herein. As illustrated in user interface 400, the reporting unit 322 may determine, based on an analysis of identified emotional responses of one or more users viewing political content, that the political content is better-received by a particular political party (e.g., members of the Democratic Party and/or members of the Republican party), a demographic, a location, an age, and/or the like. A pointer 402 may identify to which political party the political content is more relevant. In some embodiments, the direction of the pointer 402 may be determined based on a relevance score calculated by the reporting unit 322 based at least in part on an analysis of numerical values associated with identified emotional cues of one or more users as described herein. Additionally, the gesture analysis unit 322 may determine, based on identified emotional cues and/or their associated numerical values, that the user is a Democrat and/or a Republican. In this manner, the pointer 402 may point to a determination of a political identity (e.g., Democrat or Republican) of the user based on the user's emotional responses to political content.

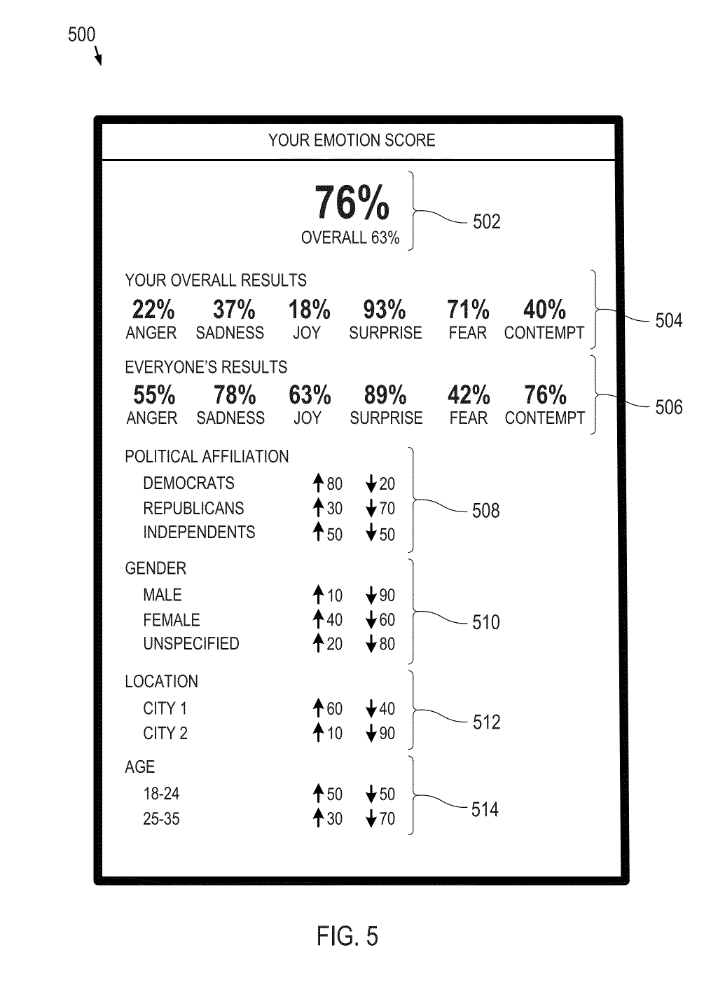

FIG. 5 shows an exemplary user interface 500 of a generated report associated with political content as described herein. As illustrated in user interface 500, the reporting unit 322 may generate a relevance score 502 associated with a user who has viewed political content based on an analysis of identified emotional cues (and/or numerical values associated with identified emotional cues) of the user in response to viewing the political content. Additionally, the reporting unit 322 may generate a second relevance score 502 associated with how well the political content was received by all users who have viewed the political content.

Overall emotional results of the user 504 who viewed the political content may be generated and/or displayed on the user interface 500 by the reporting unit 322 and may serve as a summary of which emotions were identified when the user viewed the political content. The overall emotional results of the user 504 may also include one or more generated intensity scores and/or confidence scores associated with each identified emotion of the user to indicate how strongly each emotional cue was communicated by the user during playback of the political content. Similarly, the reporting unit 322 may also generate overall emotional results of an audience 506 as a whole (e.g., all users who viewed the political content). In some embodiments, the reporting unit 322 may further determine a score associated with how probable a particular impression of political content may be to a target user, audience, and/or audience demographic.

A generated report, such as the one illustrated in user interface 500, may further include a summary of how well or poorly political content was received among various demographics. For example the report may include a percentage of all users who liked and/or disliked the political content based on political affiliation 508, gender 510, location 512, and/or age 514. In some embodiments, the reporting unit 322 may determine a user liked or disliked political content based on an analysis of identified emotional cues and/or emotions of the user. For example, if the gesture analysis unit 320 determines that positive emotions were expressed more often and/or more intensely during playback of the political content than negative emotions, thereby indicating a positive response to the political content.

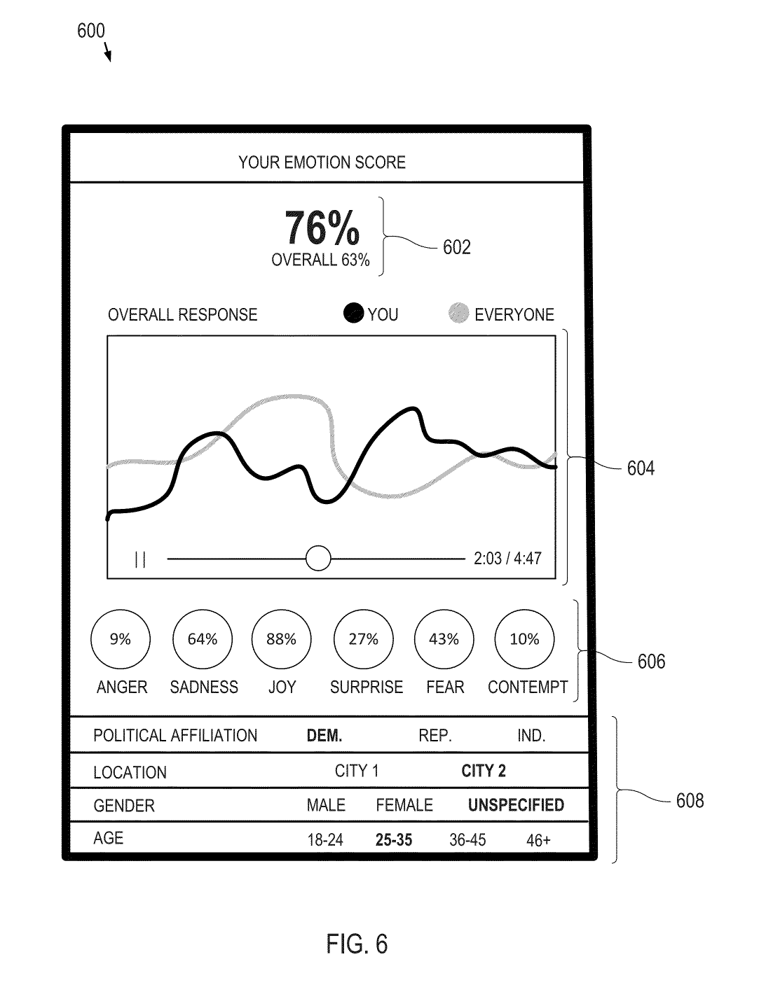

FIG. 6 shows an exemplary user interface 600 of a generated report associated with political content as described herein. As illustrated in user interface 600, the reporting unit 322 may generate a relevance score 602 similar to relevance score 502 of FIG. 5 corresponding to how relevant political content is to a user and/or an audience as a whole. The report may also include a graph 604 illustrating a calculated score (e.g., intensity score, relevance score, and/or the like) over the duration of the political content. The report may also include a summary of emotional responses 606 that highlights an intensity score of each emotion of the user identified during playback of the political content. For example, the report may identify how well a percentage of users of a particular device type in a particular location responded to political content. Further, filters 608 may enable a user to sort and/or filter data based on various demographics such as political affiliation, location, gender, and/or age. In this manner, a level of granularity in emotional analysis particular to political messages may be provided.

### Method Descriptions

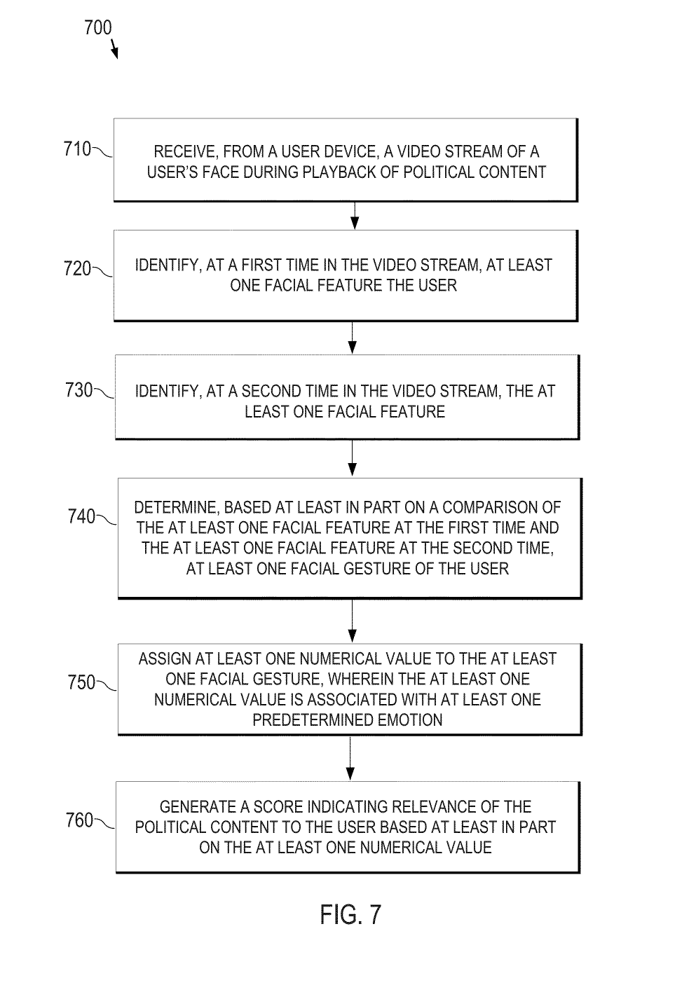

FIG. 7 shows an exemplary method 700 for performing operations associated with generating a score indicating relevance of political content to a user based on visually-detected emotional responses of the user as described herein. At block 710, the method 700 may include receiving, from a user device, a video stream of a user's face during playback of political content. At block 720, the method 700 may include identifying, at a first time in the video stream, at least one facial feature of the user. At block 730, the method 700 may include identifying, at a second time in the video stream, the at least one facial feature. At block 740, the method 700 may include determining, based at least in part on a comparison of the at least one facial feature at the first time and the at least one facial feature at the second time, at least one facial gesture of the user. At block 750, the method 700 may include assigning at least one numerical value to the at least one facial gesture, wherein the at least one numerical value is associated with at least one predetermined emotion. At block 760, the method 700 may include generating a score indicating relevance of the political content to the user based at least in part on the at least one numerical value.

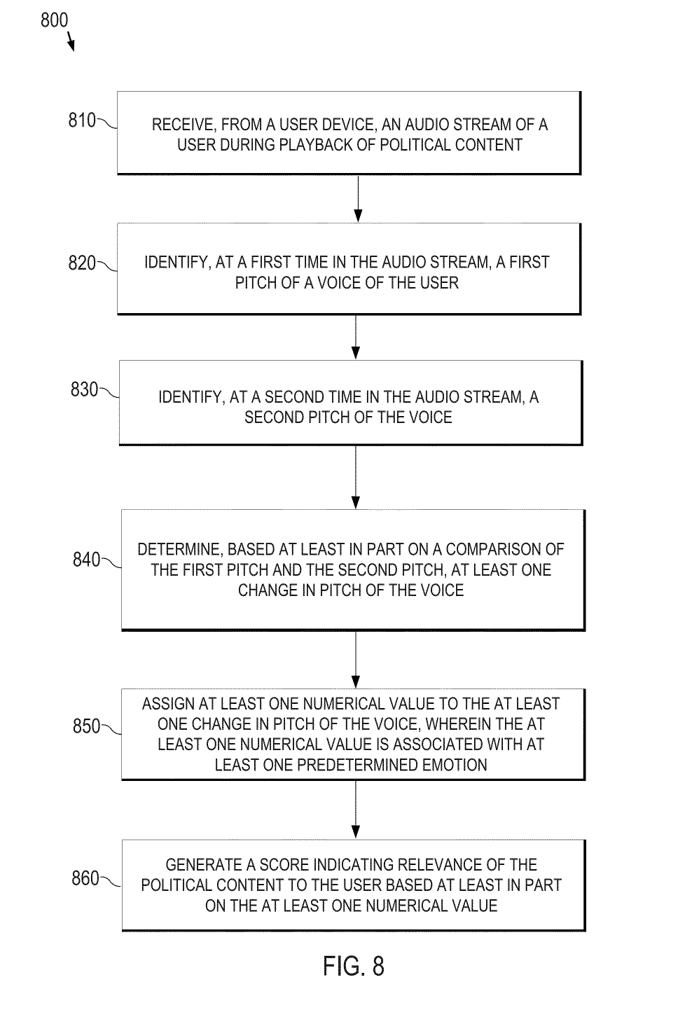

FIG. 8 shows an exemplary method 800 for performing operations associated with generating a score indicating relevance of political content to a user based on auditory emotional responses of the user as described herein. At block 810, the method 800 may include receiving, from a user device, an audio stream of a user during playback of political content. At block 820, the method 800 may include identifying, at a first time in the audio stream, a first pitch of a voice of the user. At block 830, the method 800 may include identifying, at a second time in the audio stream, a second pitch of the voice. At block 840, the method 800 may include determining, based at least in part on a comparison of the first pitch and the second pitch, at least one change in pitch of the voice. At block 850, the method 800 may include assigning at least one numerical value to the at least one change in pitch of the voice, wherein the at least one numerical value is associated with at least one predetermined emotion. At block 860, the method 800 may include generating a score indicating relevance of the political content to the user based at least in part on the at least one numerical value.

### Further Comments

While various implementations in accordance with the disclosed principles have been described above, it should be understood that they have been presented by way of example only, and are not limiting. Thus, the breadth and scope of the implementations should not be limited by any of the above-described exemplary implementations, but should be defined only in accordance with the claims and their equivalents issuing from this disclosure. Furthermore, the above advantages and features are provided in described implementations, but shall not limit the application of such issued claims to processes and structures accomplishing any or all of the above advantages.

Various terms used herein have special meanings within the present technical field. Whether a particular term should be construed as such a “term of art,” depends on the context in which that term is used. “Connected to,” “in communication with,” “communicably linked to,” “in communicable range of” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the implementations set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any implementations in this disclosure. Neither is the “Summary” to be considered as a characterization of the implementations set forth in issued claims. Furthermore, any reference in this disclosure to “implementation” in the singular should not be used to argue that there is only a single point of novelty in this disclosure. Multiple implementations may be set forth according to the limitations of the multiple claims issuing from this disclosure, and such claims accordingly define the implementations, and their equivalents, that are protected thereby. In all instances, the scope of such claims shall be considered on their own merits in light of this disclosure, but should not be constrained by the headings herein.

Lastly, although similar reference numbers may be used to refer to similar elements for convenience, it can be appreciated that each of the various example implementations may be considered distinct variations.

What is claimed is:

1. A video content server comprising:
at least one memory comprising instructions; and
at least one processing device configured for executing the instructions, wherein the instructions cause the at least one processing device to perform the operations of:
receiving, using a communication unit comprised in the at least one processing device, a video stream of a user of a user device;
analyzing, using a graphical processing unit (GPU) comprised in the at least one processing device, the video stream in real time;
identifying, using a recognition unit comprised in the at least one processing device, at least one object of interest comprised in the video stream;
assigning, using a gesture analysis unit comprised in the at least one processing device, at least one numerical value associated with at least one predetermined emotion to the at least one object of interest; and
generating, using a reporting unit comprised in the at least one processing device, a score indicating relevance of political content to the user based at least in part on the at least one numerical value.

2. The video content server of claim 1, wherein the at least one object of interest comprises at least one of a facial feature, a facial gesture, a vocal inflection, a vocal pitch shift, a change in word delivery speed, a keyword, an ambient noise, and an environment noise.

3. The video content server of claim 1, wherein the video stream comprises a live video feed of the face of a user during playback of the political content, and
wherein identifying the at least one object of interest comprises:
identifying, using the recognition unit, a facial feature of the user in the live video feed at a first time;
identifying, using the recognition unit, the facial feature of the user in the live video feed at a second time; and
determining, using the recognition unit, movement of the facial feature from a first location at the first time to a second location at the second time,
wherein the determined movement is assigned the at least one numerical value.

4. The video content server of claim 1, wherein the video stream comprises a live audio feed of the face of a user during playback of the political content, and
wherein identifying the at least one object of interest comprises:
identifying, using the recognition unit, a first vocal pitch of the first user in the live audio feed at a first time;
identifying, using the recognition unit, a second vocal pitch of the first user in the live audio feed at a second time; and
determining, using the recognition unit, a change of vocal pitch of the first user,
wherein the determined change of vocal pitch is assigned the at least one numerical value.

5. The video content server of claim 1, wherein the instructions cause the at least one processing device to perform the operations of:
generating, using the reporting unit, a report comprising the score and at least one of demographic information, personal information, political information, a graph, an email, a text message, and an infographic; and
transmitting, using the communication unit, the report to a user device associated with the user.

6. The video content server of claim 1, wherein the instructions further cause the at least one processing device to perform the operations of:
transmitting, using the communication unit, the political content to a user device associated with the user, wherein the video stream is received in response to playback of the political content on the user device.

7. The video content server of claim 1, wherein identifying the at least one object of interest comprises:
determining, using the GPU, a numerical value of at least one pixel associated with the at least one object of interest.

8. A non-transitory computer readable medium comprising code, wherein the code, when executed by at least one processing device of a video content server, causes the at least one processing device to perform the operations of:
receiving, using a communication unit comprised in the at least one processing device, a video stream of a user of a user device;
analyzing, using a graphical processing unit (GPU) comprised in the at least one processing device, the video stream in real time;
identifying, using a recognition unit comprised in the at least one processing device, at least one object of interest comprised in the video stream;
assigning, using a gesture analysis unit comprised in the at least one processing device, at least one numerical value associated with at least one predetermined emotion to the at least one object of interest; and
generating, using a reporting unit comprised in the at least one processing device, a score indicating relevance of political content to the user based at least in part on the at least one numerical value.

9. The non-transitory computer readable medium of claim 8, wherein the at least one object of interest comprises at least one of a facial feature, a facial gesture, a vocal inflection, a vocal pitch shift, a change in word delivery speed, a keyword, an ambient noise, and an environment noise.

10. The non-transitory computer readable medium of claim 8, wherein the video stream comprises a live video feed of the face of a user during playback of the political content, and wherein the non-transitory computer readable medium further comprises code that, when executed by the at least one processing device of the video content server, causes the at least one processing device to perform the operations of:
identifying, using the recognition unit, a facial feature of the user in the live video feed at a first time;
identifying, using the recognition unit, the facial feature of the user in the live video feed at a second time; and
determining, using the recognition unit, movement of the facial feature from a first location at the first time to a second location at the second time,
wherein the determined movement is assigned the at least one numerical value.

11. The non-transitory computer readable medium of claim 8, wherein the video stream comprises a live audio feed of the face of a user during playback of the political content, and wherein the non-transitory computer readable medium further comprises code that, when executed by the at least one processing device of the video content server, causes the at least one processing device to perform the operations of:
identifying, using the recognition unit, a first vocal pitch of the first user in the live audio feed at a first time;
identifying, using the recognition unit, a second vocal pitch of the first user in the live audio feed at a second time; and
determining, using the recognition unit, a change of vocal pitch of the first user,
wherein the determined change of vocal pitch is assigned the at least one numerical value.

12. The non-transitory computer readable medium of claim 8, wherein the non-transitory computer readable medium further comprises code that, when executed by the at least one processing device of the video content server, causes the at least one processing device to perform the operations of:
generating, using the reporting unit, a report comprising the score and at least one of demographic information, personal information, political information, a graph, an email, a text message, and an infographic; and
transmitting, using the communication unit, the report to a user device associated with the user.

13. The non-transitory computer readable medium of claim 8, wherein the non-transitory computer readable medium further comprises code that, when executed by the at least one processing device of the video content server, causes the at least one processing device to perform the operations of:
transmitting, using the communication unit, the political content to a user device associated with the user, wherein the video stream is received in response to playback of the political content on the user device.

14. The non-transitory computer readable medium of claim 8, wherein the non-transitory computer readable medium further comprises code that, when executed by the at least one processing device of the video content server, causes the at least one processing device to perform the operations of:
determining, using the GPU, a numerical value of at least one pixel associated with a facial feature identified in the video content.

15. A method comprising:
receiving, using a communication unit comprised in at least one processing device of a video content server, a video stream of a user of a user device;
analyzing, using a graphical processing unit (GPU) comprised in the at least one processing device, the video stream in real time;
identifying, using a recognition unit comprised in the at least one processing device, at least one object of interest comprised in the video stream;
assigning, using a gesture analysis unit comprised in the at least one processing device, at least one numerical value associated with at least one predetermined emotion to the at least one object of interest; and
generating, using a reporting unit comprised in the at least one processing device, a score indicating relevance of political content to the user based at least in part on the at least one numerical value.

16. The method of claim 15, wherein the at least one object of interest comprises at least one of a facial feature, a facial gesture, a vocal inflection, a vocal pitch shift, a change in word delivery speed, a keyword, an ambient noise, and an environment noise.

17. The method of claim 15, wherein the video stream comprises a live video feed of the face of a user during playback of the political content, and wherein the method further comprises:
identifying, using the recognition unit, a facial feature of the user in the live video feed at a first time;
identifying, using the recognition unit, the facial feature of the user in the live video feed at a second time; and
determining, using the recognition unit, movement of the facial feature from a first location at the first time to a second location at the second time,
wherein the determined movement is assigned the at least one numerical value.

18. The method of claim 15, wherein the video stream comprises a live audio feed of the face of a user during playback of the political content, and wherein the method further comprises:
identifying, using the recognition unit, a first vocal pitch of the first user in the live audio feed at a first time;
identifying, using the recognition unit, a second vocal pitch of the first user in the live audio feed at a second time; and
determining, using the recognition unit, a change of vocal pitch of the first user,
wherein the determined change of vocal pitch is assigned the at least one numerical value.

19. The method of claim 15, wherein the method further comprises:
generating, using the reporting unit, a report comprising the score and at least one of demographic information, personal information, political information, a graph, an email, a text message, and an infographic; and
transmitting, using the communication unit, the report to a user device associated with the user.

20. The method of claim 15, wherein the method further comprises:
transmitting, using the communication unit, the political content to a user device associated with the user, wherein the video stream is received in response to playback of the political content on the user device.
